(19) United States
(12) Patent Application Publication
(10) Pub. No.: US 2015/0226120 A1
(43) Pub. Date: Aug. 13, 2015

(54) DUCTS FOR ENGINES

(71) Applicant: Reaction Engines Ltd., Abingdon (GB)

(72) Inventors: Alan Bond, Abingdon (GB); Richard Varvill, Abingdon (GB)

(21) Appl. No.: 14/296,607

(22) Filed: Jun. 5, 2014

(30) Foreign Application Priority Data
Oct. 11, 2013 (GB) 1318101.1

(51) Int. Cl. F02C 7/04

(52) U.S. Cl. CPC F02C 7/04

(57) ABSTRACT

A duct for forming a generally annular passage such as an inlet to a turbine, the duct having a plurality of tubes angularly spaced from one another and distributed around an axis.

### CROSS-REFERENCE TO RELATED APPLICATIONS

The present application claims priority under 35 U.S.C. §119(a) to the following application filed in the United Kingdom on Oct. 11, 2013, which is incorporated herein by reference: GB 1318101.1.

### FIELD

The present disclosure relates to ducts for turbine inlets and to engines including such ducts. The invention may also be employed in other passages of engines, including such engines which include at least one turbomachine.

### BACKGROUND

It is commercially desirable to develop a reusable high-speed, single stage to orbit (SSTO) aircraft. One example of this may be an aircraft having an engine with two modes of operation: an air-breathing mode and a rocket mode capable of propelling the aircraft to speeds beyond Mach 5, e.g. into orbit.

In such an engine, a contra-rotating helium turbine is fed at high pressure from an axisymmetric annular heat exchanger. It is difficult to produce ducting capable of withstanding such high pressure without deformation without using thick and therefore heavy components likely to have an adverse effect on fuel consumption and economy

### SUMMARY

Embodiments of the present disclosure attempt to mitigate at least some of the above-mentioned problems.

In accordance with first aspect of the disclosure there is provided a duct for forming a generally (or overall) annular passage such as an inlet to a turbine, the duct comprising a plurality of tubes angularly spaced from one another and distributed around an axis.

The passage can comprise a plurality of discrete flow pathways. The tubes can form such flow pathways. The annular passage may allow fluid flow in a generally radial direction.

The duct may have two open ends.

One open end of the duct may be connected to or lead towards a heat exchanger.

One open end of the duct may be connected to or lead towards a turbine.

Alternatively, ends of the duct may link to any other engine component such as to a compressor, pump, heat exchanger or combustion component.

The duct may be arranged for the passage of fluid, such as a gas (helium being an example of such a gas), from the heat exchanger to the turbine via the duct.

The duct may be arranged for operating at internal pressure over 100 bar, for example in the region of 25 bar to 300 bar, 200 bar being an example.

Each of the tubes may support the pressure of the fluid, including at such pressures mentioned above, substantially without deformation of the tubes. The tubes may deform slightly but less than a single annular duct would.

The duct, the heat exchanger and the turbine may have a common axis.

Each of the tubes may have an annular passage width of 5 mm to 200 mm, 10 mm being an example.

Each of the tubes may have a wall thickness, in at least a portion or all throughout, of 0.1 mm to 10 mm, 0.7 mm being an example.

Each of the tubes may have a generally racetrack cross-section, for example having two arcuate edges joined to one another by two generally flat connector portions.

Each of the tubes may be formed of a metal alloy or composite material, nickel alloy being an example.

The duct may be configured with the tubes arranged consecutively in a series and optionally in contact with at least one other of the plurality of tubes. The tubes may thus abut against each other and support each other when under pressure. The pressure across the connecting walls may be balanced.

In accordance with a second aspect of the disclosure, there is provided an engine comprising a duct for forming an inlet to a turbine, wherein the duct comprises a plurality of tubes angularly spaced from one another and distributed around an axis.

The engine may have a rocket mode and an air-breathing mode.

### BRIEF DESCRIPTION OF THE DRAWINGS

A preferred embodiment of a duct in accordance with the disclosure, and an engine including the same, will now be described by way of example only and with reference to the accompanying drawings in which:

FIG. 1 shows a schematic cross-section through a turbine inlet duct, with lines showing deformed shape, this arrangement being background information useful for understanding the invention;

FIG. 2 is a schematic side elevation of an engine that comprises a turbine inlet duct according to an embodiment;

FIG. 3 shows a schematic cross section through plane A-A shown in FIG. 2;

FIG. 4 shows a schematic cross section through a modified embodiment;

FIG. 5 shows a schematic cross section through another embodiment;

FIG. 6 shows how pressure is applied in the duct of FIG. 5;

FIG. 7 is a view of part of the embodiment of FIG. 5 demonstrating where a radius is located; and

FIG. 8 is a schematic view comparing radii of a tube of FIG. 5 with a radius of a single large annular duct.

Throughout the description and the drawings, like reference numerals refer to like parts.

### DETAILED DESCRIPTION

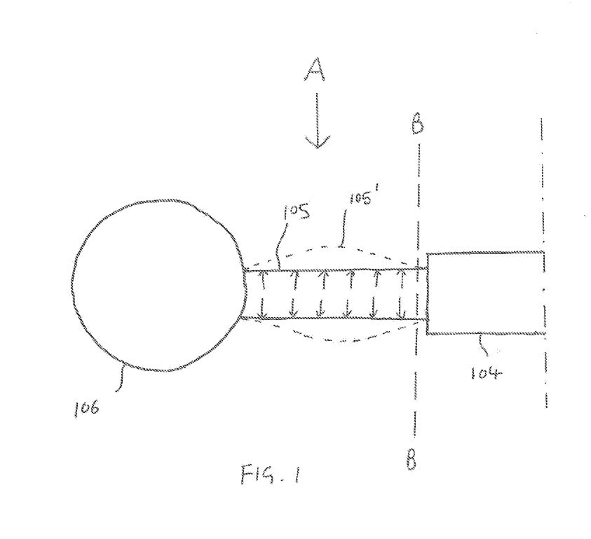

FIG. 1 shows the effect that high pressure helium would have on a turbine inlet duct formed of two annular shells. If helium is fed from heat exchanger 106 to turbine 104 via turbine inlet duct 105 at 200 bar, the high pressure acts on turbine inlet duct 105 and caused the duct to deform, to shape 105′. This deformation causes large bending moments in the turbine inlet duct 105 at the connections to turbine 104 and heat exchanger 106. To sustain the large bending moment, an annular inlet formed of two annular shells requires shells of high thickness and therefore high weight. Increased weight of the engine results in reduced performance, including increased specific fuel consumption.

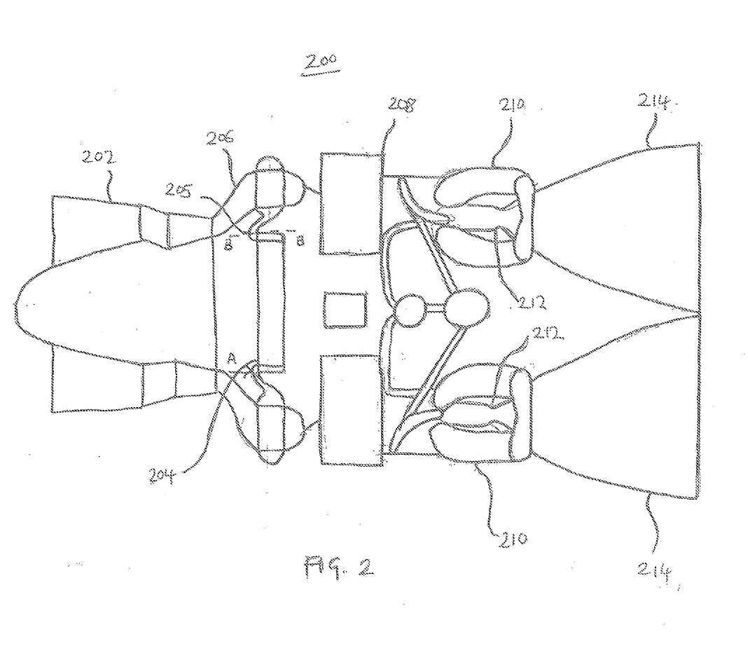

FIG. 2 shows a schematic of an engine 200 in accordance with a preferred embodiment of the disclosure and for use in a reusable high-speed, SSTO aircraft. The engine 200 comprises a compressor 202, a turbine 204, turbine inlet duct 205, heat exchangers 206 and 208, air-breathing combustion chambers 210, rocket combustion chambers 212 and nozzles 214. Turbine 204 and heat exchanger 206 are arranged coaxially or roughly coaxially—they do not have to be coaxial. Turbine inlet duct 205 comprises a plurality of individual tubes 300 angularly spaced relative to one another and distributed in a series around the same axis to form an annular arrangement of the tubes. Each tube comprising turbine inlet duct 205 is connected at one end to turbine 204 and at the other end to heat exchanger 206. Each individual tube has an annular passage width of 1 cm (or 1 cm to 2 cm). In other embodiments, the diameter may be different. The wall thickness of each tube is 0.7 mm. In other embodiments, the wall thickness may be different. The tubes are of generally racetrack cross-section having two generally flat opposing wall sections joined by generally arcuate, curved wall sections. In other embodiments the cross section may be different. The number of tubes is dependent on the application, and may be between, for example, 100 and 200. In order to reduce the axial length of the engine 200, each tube 300 is curved to take the form of a swan-neck such that fluid flows along a swan-neck shaped path. Each tube is formed of nickel alloy. In other embodiments, other materials may be used.

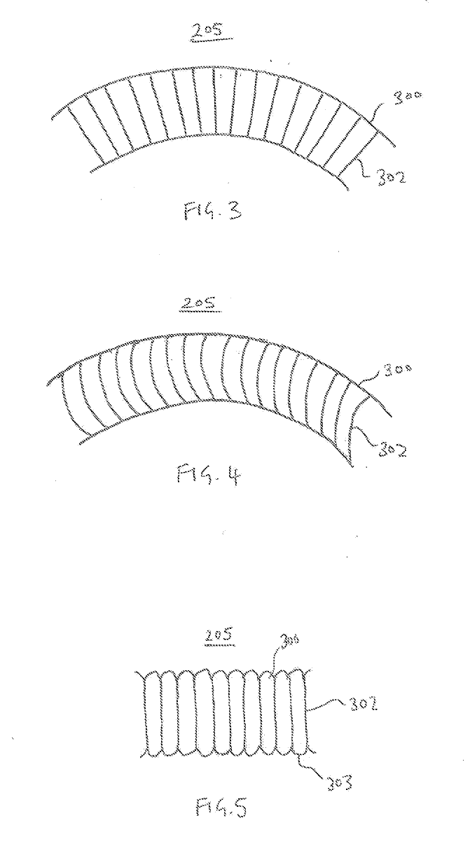

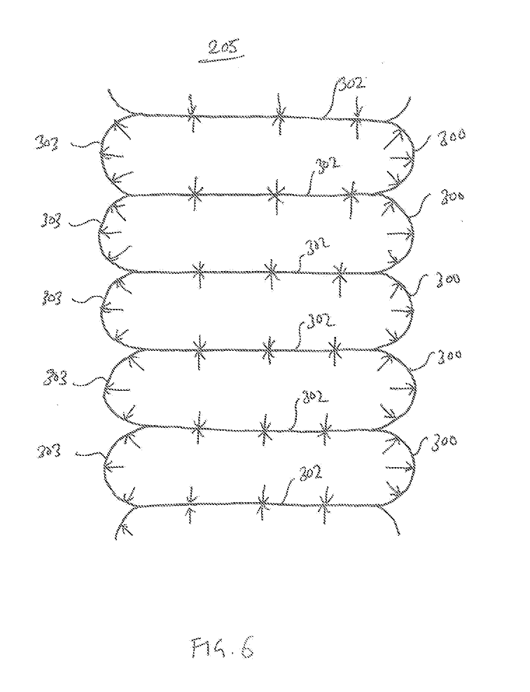

In operation, the turbine inlet duct 205 receives high pressure helium from heat exchanger 206. As shown in FIGS. 3 to 5, turbine inlet duct 205 comprises individual tubes 300 angularly spaced and distributed around the axis of the heat exchanger 206 and the turbine 204. FIG. 3 depicts the turbine inlet duct shown from view A of FIG. 1. FIG. 3 shows a configuration in which the wall portions 302 connecting the tubes 300 are radially straight. Helium flows generally radially from the radially outer ends of the tubes 300 to the radially inner ends. In another configuration, helium may flow generally radially from the radially inner ends of the tubes 300 to the radially outer ends. The tubes 300 have a tapered width in order to form an annulus. FIG. 4 depicts an alternative configuration of the turbine inlet duct, again shown from view A of FIG. 1. FIG. 4 shows a configuration in which the tubes 300 have a constant passage width with curved connecting walls. The tubes 300 are arranged in an involute spiral in order to form an annular duct. FIG. 5 depicts the turbine inlet duct through cross section B of FIG. 1, according to the configurations shown in FIG. 3 or FIG. 4. FIG. 5 shows a configuration in which the connecting wall portions 302 between tubes 300 are radially straight, and each of the tubes 30 has an end portion 303 with generally circular cross section. Helium flow is generally perpendicular to the plane of the cross-section.

FIG. 6 shows the balance of pressure in tubes 300 in the configuration shown in FIG. 5. The pressure of the helium, at 200 bar, acts on the walls of each of the individual tubes 300. Internal supporting wall portions 302 of the tubes 300 are substantially straight and support the axial separation force due to the pressure in tension. The internal pressure acting on end portions 303 resolves into an axial separation force and this is supported by the internal supporting wall portions 302. The pressure of the helium is therefore distributed across the multiple tubes 300 and is balanced either side of the internal supporting wall portions 302. This therefore largely eliminates bending stress at the connections between turbine inlet duct 205 and heat exchanger 206 and turbine 204.

Furthermore, the weight of turbine inlet duct 205 is reduced. The inventors have calculated that relation between wall thickness (t), internal pressure (P), duct radius (r) and allowable stress (σ) is given by the following equation:

t=P·r/σ

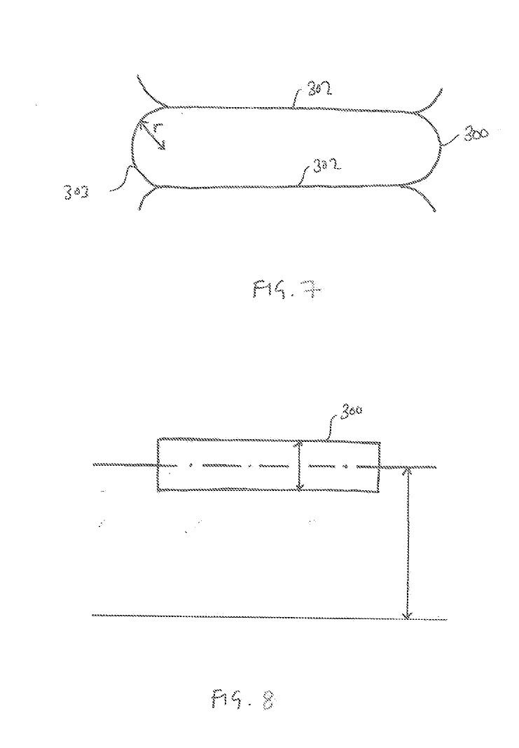

The duct radius for embodiments of the present disclosure is defined as shown in FIG. 7. The radius for a particular tube is the radius of its generally circular-section end portion 303. An annular turbine inlet duct formed of two shells has a large radius and therefore requires a large wall thickness. This leads to a large weight of the turbine inlet duct. The individual tubes 300 have a much smaller radius, and therefore a reduced wall thickness. Therefore, the weight of the turbine inlet duct 205 is reduced in comparison to a single annular turbine inlet duct formed of two annular shells. This is shown in FIG. 8, which depicts a tube of radius ‘r’ (say, 20 mm) and an annular duct of radius ‘10r’ (say, 200 mm). Following the above equation, the annular duct would have a wall thickness 10 times that of the tubular duct. The weight of the turbine inlet ducting is reduced by at least an order of magnitude in embodiments of the present disclosure.

This results in increased performance of the engine, including reduced specific fuel consumption.

Various modifications may be made to the described embodiments without departing from the scope of the invention as defined by the accompanying claims.

1. A duct for forming a generally annular passage, the duct comprising:
a plurality of tubes;
wherein the plurality of tubes are angularly spaced from one another and distributed around an axis.

2. A duct as claimed in claim 1, wherein the duct has two open ends.

3. A duct as claimed in claim 2 wherein one open end of the duct is connected to or leads towards a heat exchanger.

4. A duct as claimed in claim 3 wherein the other open end of the duct is connected to or leads towards a turbine.

5. A duct as claimed in claim 4 wherein the duct allows the passage of fluid from the heat exchanger to the turbine via the duct.

6. A duct as claimed in claim 4 wherein the duct operates at internal pressure of over 100 bar.

7. A duct as claimed in claim 6 wherein each of the tubes is arranged to support the internal pressure, without substantial deformation of the tubes.

8. A duct as claimed in claim 3 wherein the duct, the heat exchanger and the turbine have a common axis.

9. A duct as claimed in claim 1 wherein each of the tubes has an annular passage width between 5 mm and 20 mm.

10. A duct as claimed in claim 1, wherein each of the tubes comprises a wall, at least a portion of the wall having a thickness of 0.2 mm to 2 mm.

11. A duct as claimed in claim 1 wherein each of the tubes comprises:
a generally elliptical or racetrack cross-section, and curved end-portions configured to withstand the internal pressure in the tubes.

12. A duct as claimed in claim 1 wherein each of the tubes is formed of nickel alloy or composite material.

13. A duct as claimed in claim 1 wherein the plurality of tubes are arranged consecutively in a series.

14. A duct as claimed in claim 13 wherein each of the plurality of tubes is in contact with at least one other of the plurality of tubes.

15. A duct as claimed in claim 14 wherein the tubes abut against each other and support each other when under pressure.

16. A duct as claimed in claim 14 wherein the tubes are configured to have a balanced pressure across connecting walls between the tubes.

17. An engine comprising a duct for forming an inlet to a turbine, wherein the duct comprises a plurality of tubes angularly spaced from one another and distributed around an axis.

18. An engine as claimed in claim 17 wherein the engine has a rocket mode and an air-breathing mode.
